(19) United States
(12) Patent Application Publication
(10) Pub. No.: US 2008/0062204 A1
(43) Pub. Date: Mar. 13, 2008

(54) Automated pixel snapping for anti-aliased rendering

(75) Inventors: Seema Ramchandani, Seattle, WA (US); Mikhail Lyapunov, Woodinville, WA (US); Dmitry Titov, Redmond, WA (US); Oleg Ovetchkine, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/518,029

(22) Filed: Sep. 8, 2006

(51) Int. Cl. G09G 5/00

(52) U.S. Cl. 345/677

(57) ABSTRACT

An anti-aliased computer display system has graphical elements that may be defined with a pixel-snapping property that causes the elements to be shifted or transformed to align with the pixel map of a display. When the property is set, horizontal and vertical guidelines are established that are used to calculate a transformation for the elements, and the transformation is applied to the element plus any child elements. In some cases, guidelines may be established for both the right and left as well as top and bottom of the elements, and portions of the graphical elements that end on or are collinear with the guidelines may be transformed by shifting or stretching the elements. In general, the transformation is a translation that is less than one pixel in size. The result is a pixel-snapped image that may be displayed on any type of display with any resolution while remaining crisp and clear, just as the designer intended.

### BACKGROUND

Anti-aliasing is a technique used to display lines, curves, and other images on a computer display. A computer display is made up of small, discrete elements called pixels typically arranged in a grid. When a curve is displayed without anti-aliasing, the edge of the curve may appear jagged as the discrete pixels are used to approximate the curve. Rather than having the pixels to be either on or off, anti-aliasing enables those pixels in the jagged portion of the curve to have a partial intensity, calculated based on the amount of the original line the original curve would have covered for that pixel.

Anti-aliasing is a very powerful and useful technique for enhancing computer graphic displays, and has been widely adapted. However, in some cases, anti-aliasing can lead to some images that are not desirable. For example, some vertical or horizontal lines in a graphical user interface may be distorted or ‘grayed’ when those lines do not align precisely with the pixels of the computer display. In those cases, a designer may position those lines more precisely to achieve a crisp look and feel to the user interface. A problem arises when the same image is displayed using a different pixel resolution because the image may not display as desired.

### SUMMARY

In an anti-aliased computer display system, graphical elements may be defined with a pixel-snapping property that causes the elements to be shifted or transformed to align with the pixel map of a display. When the property is set, horizontal and vertical guidelines are established that are used to calculate a transformation for the elements, and the transformation is applied to the element plus any child elements. In some cases, guidelines may be established for both the right and left as well as top and bottom of the elements, and portions of the graphical elements that end on or are collinear with the guidelines may be transformed by shifting or stretching the elements. In general, the transformation is a translation that is less than one pixel in size. The desired result is a pixel-snapped image that may be displayed on any type of display with any resolution while remaining crisp and clear, just as the designer intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a hierarchical definition of graphical elements.

FIG. 2 is a pictorial illustration of an embodiment showing button primitives with guidelines.

FIG. 3 is a pictorial illustration of an embodiment showing pixel snapping transformation of a button border.

FIG. 4 is a pictorial illustration of an embodiment showing pixel snapping transformation of an icon.

FIG. 5 is a flowchart illustration of an embodiment showing a method for pixel snapping.

FIG. 6 is a pictorial illustration of an embodiment showing a system for pixel snapping.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

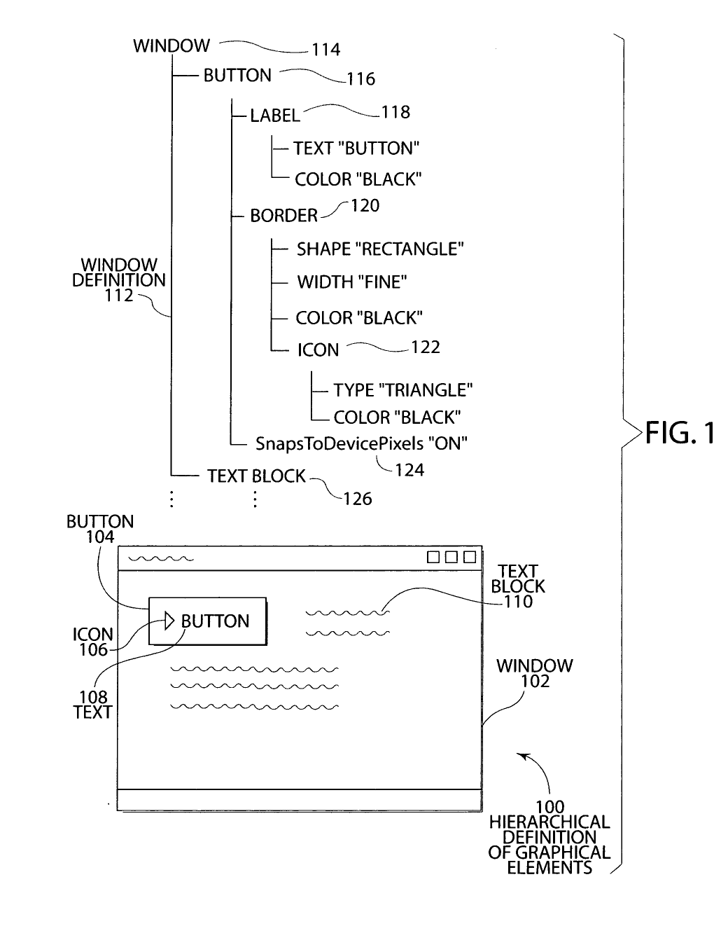

FIG. 1 is a diagram of an embodiment 100 showing a hierarchical definition of graphical elements. A window 102 has a button 104 with an icon 106 and some text 108. The window 102 also contains a textblock 110.

The window definition 112 is a hierarchical definition of the elements that comprise the window 102. The window definition 112 contains a window 114 that has child elements button 116 and textblock 126. The button element 116 contains child elements label 118, border 120, and SnapsToDevicePixels 124, which is set to “ON”. The border element 120 contains a child element icon 122 as well. The window definition 112 may additionally contain many more elements than those presented.

The window definition 112 is used by a software system that interprets the window definition 112 and creates the actual window 102 on a display that is viewable by a user. The window definition 112 is a hierarchical definition, and may allow some properties, such as SnapsToDevicePixels 124 to be inherited to child elements. The software system that creates data used by a display to render the window 102 may be an integral part of an operating system, a shared library of routines that is used by several applications, or may be embedded within a single computer application.

Each of the various elements may have one or more parameters that help to define the element. For example, the border element 120 is defined by shape, width, and color parameters.

The hierarchical window definition 112 contains many different elements. Some elements, such as the button element 116, may be merely empty containers or non-displayable elements that consolidate several child elements together. Because of the hierarchical nature of the definition, properties or parameters, such as SnapsToDevicePixels 124, may be inherited or applied to all child elements as a group.

Another type of element in the window definition 112 is a primitive such as border 120 and icon 122. A primitive, for the purposes of this specification, are those elements that are visually displayed on a display screen. The primitives border 120 and icon 122 generate the rectangular box around the edge of the button 104 and the triangle-shaped icon 106.

Pixel snapping is a technique whereby an object is aligned so that the object is displayed using full pixels, rather than appearing as a blurred line when anti-aliasing techniques are applied. By using full pixels, lines, especially horizontal and vertical lines, are displayed in a clean, crisp fashion. Other shapes may also appear more clean when pixel-snapped as well, including those shapes that have a horizontal or vertical axis of symmetry. When applied to a parent element such as the button element 116 in the hierarchical structure of the window definition 112, the pixel snapping property may be inherited by the child elements of the parent, including successive child elements of the first child elements.

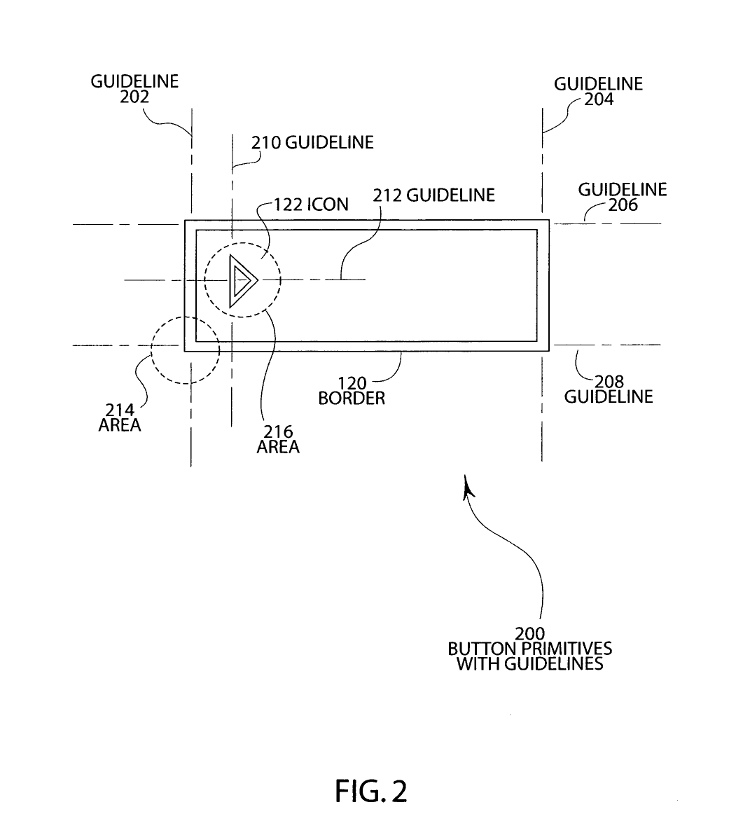

FIG. 2 is an illustration of embodiment 200 showing button primitives with guidelines. The border 120 and icon 122 are illustrated. Border 120 has two vertical guidelines 202 and 204, and two horizontal guidelines 206 and 208. Icon 122 has a single vertical guideline 210 and a single horizontal guideline 212. The areas 214 and 216 are discussed in later figures.

The button primitives border 120 and icon 122 have guidelines which may be used to align the primitives to a pixel grid when the primitives are displayed. The embodiment 200 may be an example of a definition of the primitives in a device independent coordinate system. For example, a layout system may provide tools for a designer to define the look and feel of a graphical user interface. The graphical user interface may be used on many different devices, each of which may have different screen sizes and screen resolutions. When the primitives are being prepared for display, the various guidelines may be used to align the primitives to the pixel grid of the intended display such that the primitives appear sharp and crisp.

Guidelines may be defined in several different manners for the primitives. In some cases, the guidelines may be defined on the centerline of a line that makes up a primitive. In the present embodiment of the border 120, the guidelines are so defined. In the icon 122, the vertical guideline 210 is defined in the centerline of the vertical portion of the icon 122, and the horizontal guideline 212 is defined in the vertical point of symmetry of the icon 122. In other embodiments, a guideline may be defined as an edge of a line or in any other suitable fashion. The examples in this specification will show a guideline being defined as the centerline of a line rather than an edge.

Pixel snapping is a tradeoff between the precise position of a primitive on the display and the crispness that comes from being aligned with the pixel grid. For example, when a designer lays out the primitives in embodiment 200, there is a precise relationship between the icon 122 and the border 120. Because the designer enabled pixel snapping, the border 120 and icon 122 may be shifted slightly such that the primitives are aligned with the pixels of the display device. In some instances, one element such as the border 120 may be shifted a small amount to the left while the icon 122 may be shifted a small amount to the right. This shifting may change the designer's precise layout ever so slightly at the expense of crispness of the images on the display.

In some cases, guidelines may be individually and separately defined by a designer when an element is laid out in a graphical representation. In other cases, guidelines may be automatically generated.

A manually generated guideline may be done in many ways. In some cases, a guideline may be defined prior to defining other elements, and those elements may be associated with the guideline. In such a case, the guideline may be used to snap other objects in line when the objects are created. In other cases, a portion of an element may be designated by a designer, and a guideline may be created along that portion. The designer may highlight a portion of an element, such as a vertical line, and create a guideline that is parallel to that portion of the element.

Automatically generated guidelines may include guidelines that are defined with a primitive. For example, the icon primitive 122 may be defined with guidelines 210 and 212 as part of a library definition of the icon primitive 122. In another example, a shape that is rectangular may have guidelines automatically generated by assigning guidelines to the horizontal and vertical limits of the shape. Most of the elements that benefit from pixel snapping are those that contain horizontal and vertical lines, which are generally rectangles. Thus, a default guideline generation routine may use the four rectangular bounds of an object as pixel snapping guidelines.

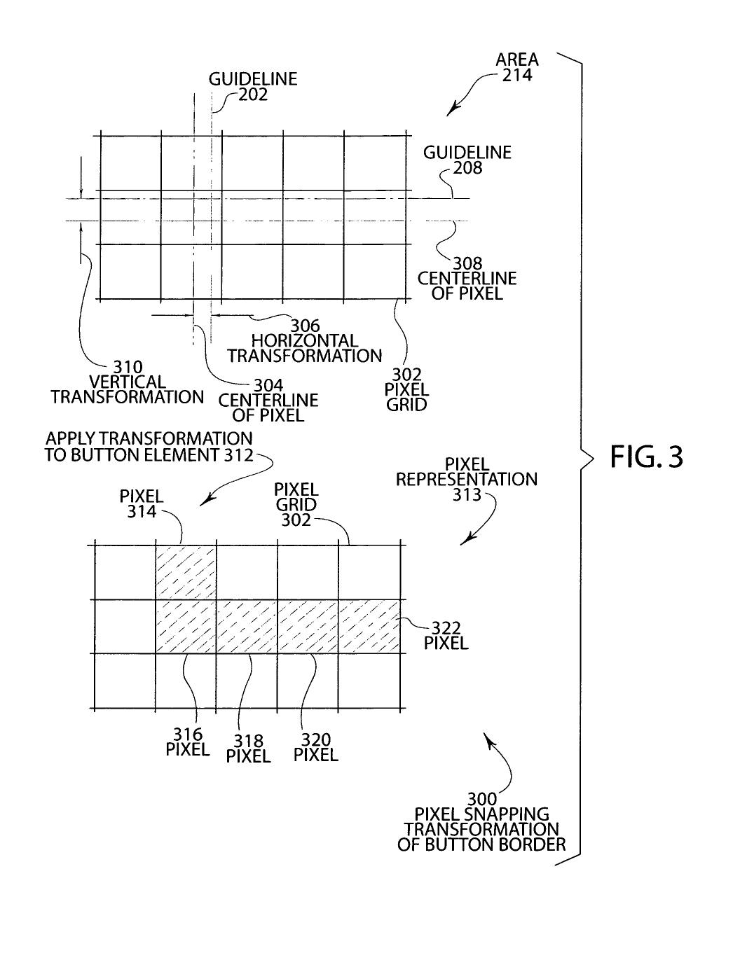

FIG. 3 is an illustration of an embodiment 300 showing pixel snapping transformation as applied to the button border. The pixel grid 302 is determined by selecting an output device and associated parameters. The embodiment 300 illustrates the area 214 from FIG. 2.

Guideline 202 is the vertical guideline on the left side of the button border 120. Guideline 202 is offset to the right of the centerline 304 of the nearest pixel by a distance that becomes the horizontal transformation 306. Similarly, guideline 208 is offset to the top of the centerline 308 of the nearest pixel in the vertical axis. The distance of the vertical offset becomes the vertical transformation 310.

The transformation of the border object 120 is a combination of both the horizontal transformation 306 and the vertical transformation 310. The transformation is applied 312 to yield the pixel representation 313. On the pixel grid 302, the pixels 314, 316, 318, 320, and 322 are fully turned on to create the lower left hand corner of the border element 120. Such a representation of the border object 120 would display crisply and cleanly on a display.

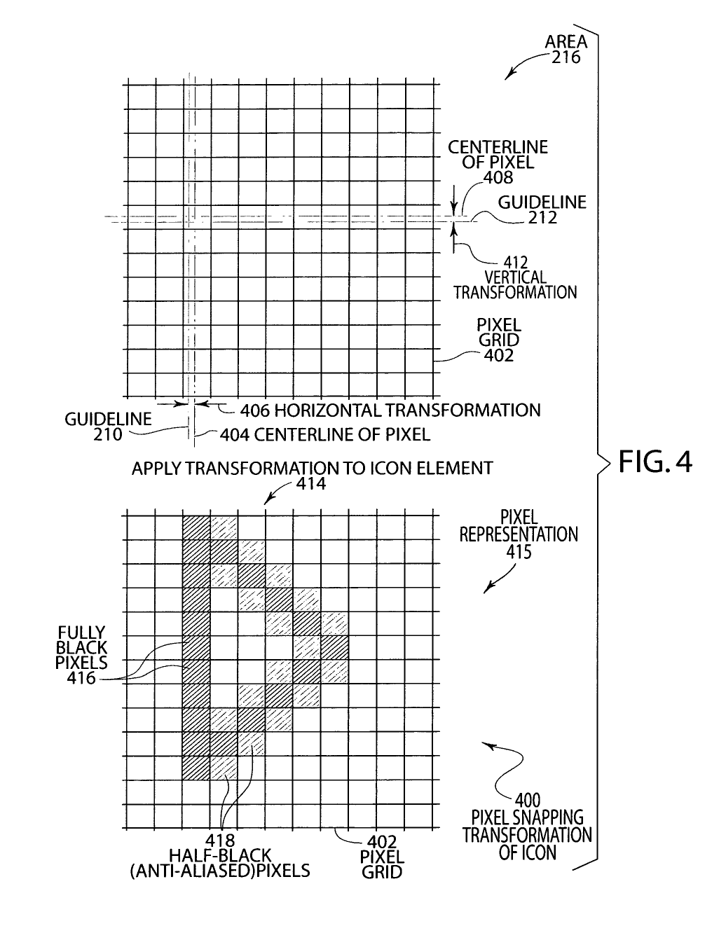

FIG. 4 is an illustration of an embodiment 400 showing a pixel snapping transformation as applied to the icon. The pixel grid 402 is determined by selecting an output device and associated parameters. The embodiment 400 illustrates the area 216 from FIG. 2.

Guideline 210 is the vertical guideline on the vertical axis of the icon 122. Guideline 210 is offset to the left of the centerline 404 of the nearest pixel by a distance that becomes the horizontal transformation 406. Similarly, guideline 212 is offset to the bottom of the centerline 408 of the nearest pixel in the vertical axis. The distance of the vertical offset becomes the vertical transformation 412.

The transformation of the icon object 122 is a combination of both the horizontal transformation 406 and the vertical transformation 412. The transformation is applied 414 to yield the pixel representation 415. On the pixel grid 402, the fully black pixels 416 are those that fully align with the pixel grid 402, while the half-black or anti-aliased pixels 418 are those that are partially illuminated so that the angled lines of the icon 122 do not appear like rough ‘stair-steps’.

The icon 122 is a child of the border element 120, yet both elements inherited the SnapsToDevicePixels property 124 from the button definition 116. The pixel snapping process was applied to the two elements separately, and in the example, the border 120 was shifted slightly downwardly and to the left. The icon 122 was shifted slightly upwardly and to the right. The resulting image was slightly different placement of the elements from the original design. However, the image is a sharper, crisper image because the vertical and horizontal portions of the image are not anti-aliased and thus blurry or ‘gray’.

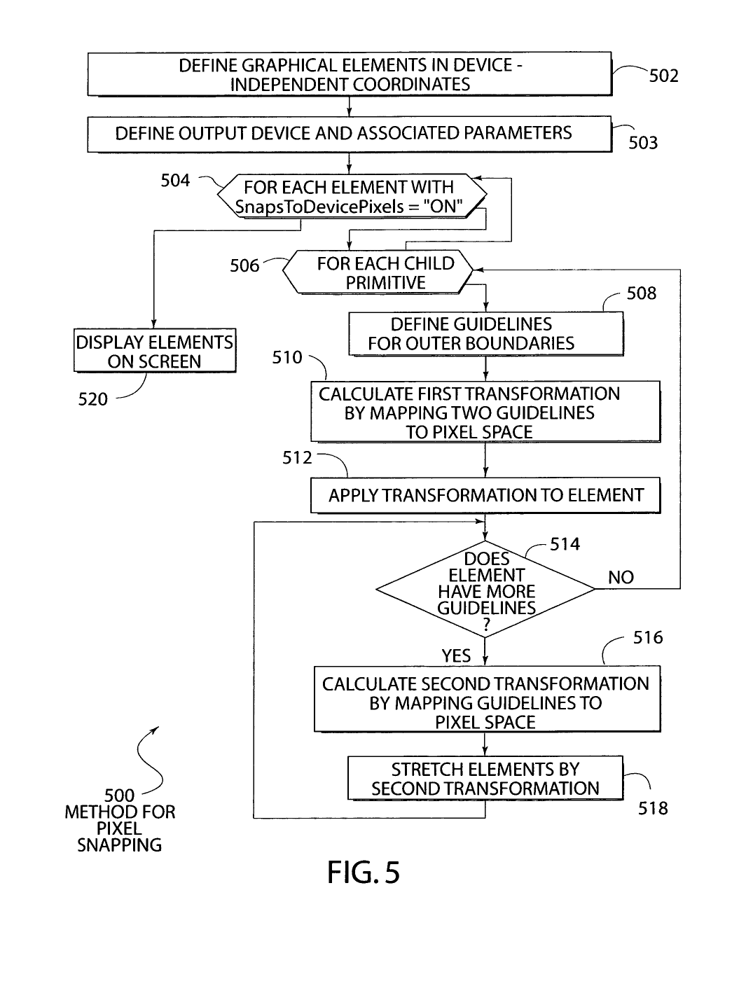

FIG. 5 is a flowchart illustration of an embodiment 500 showing a method for pixel snapping. The graphical elements are defined in device-independent coordinates in block 502. The output device and associated parameters are defined in block 503. For each element with pixel snapping=“ON” in block 504, and for each child primitive in block 506, guidelines are defined in block 508. In block 510, a first transformation is calculated by mapping two guidelines to pixel space, and the transformation is applied in block 512.

If the element does have additional guidelines in block 514, a second transformation is calculated by mapping guidelines to pixel space in block 516, and the second transformation is applied by stretching the elements in block 518, whereupon the process returns to block 514. If the element does not have any more guidelines in block 514, the process reverts to block 506, and if all primitives are handled in block 506, the process reverts to block 504. If all elements are processed in block 504, the elements are displayed in block 520.

Embodiment 500 illustrates one method of how pixel snapping may be applied to a hierarchical element structure. The tree of hierarchical elements is traversed and pixel snapping is applied to each element, with the pixel snapping property being inherited to child elements along the tree.

Embodiment 500 also illustrates how multiple guidelines may be applied to elements. A first set of guidelines may be used to transform the entire primitive or element, but a second or subsequent set of guidelines may be used to stretch the element to conform to the pixel grid. In the previous example of the border 120, the first set of guidelines 202 and 208 were used to align the lower left corner of the border 120. The second set of guidelines 204 and 206, may be used to stretch the border 120 such that the upper right corner is aligned with the pixel grid. It should be noted that the term to stretch in this context may involve increasing or decreasing the width or height of the element to conform the edges of the said element to the pixel grid. As with most pixel snapping operations, the movement or shift of an element is typically less than one pixel in distance.

In some embodiments, multiple guidelines may be applied in a different manner. In such a case, each transformation may be used to stretch the portions of the element that cross, connect, align, or otherwise come in contact with the guideline. Each set of guidelines may create a transformation that is applied independently of another set of guidelines, as opposed to the previous example where the first transformation is applied to the entire element, and subsequent transformations are applied as stretch operations.

The definition of graphical elements in block 502 may be performed when a computer application is developed, and the output device and associated parameters may be applied to the hierarchical graphical definition at runtime of the application. In some cases, an application may switch display characteristics during runtime, such as in the case where a system has multiple displays or where a user changes display settings during the operation.

The pixel snapping routine may be performed in real time as a computer application is generating images for display on an output device such as a computer screen or display. In some cases, such routines may be implemented in hardware or software, or a separate processor may be dedicated to performing the display generation. In other cases, a multipurpose computer system with a single general purpose processor may be used to perform the pixel snapping functions. Some embodiments may use a generic pixel snapping routine as part of a display driver or other software component in an operating system or application development system.

The parameters associated with the display in block 503 may include the pixel spacing, resolution, zoom factor, color capabilities, or any other parameter that may be used by the pixel snapping routine or other display related processing.

In some cases, the guidelines defined in block 508 may be defined at runtime, while in other cases the guidelines may be defined ahead of time in block 502. Some applications may use a combination of predefined guidelines and those created automatically at runtime. When a combination of guidelines is used, some situations may give priority to those guidelines defined at runtime while other situations may give priority to predefined guidelines. In some embodiments, a guideline with a high priority may be applied before a lower priority guideline. In other embodiments, a high priority guideline may be applied instead of a lower priority guideline. In still other embodiments, a high priority guideline may be applied after a lower priority guideline.

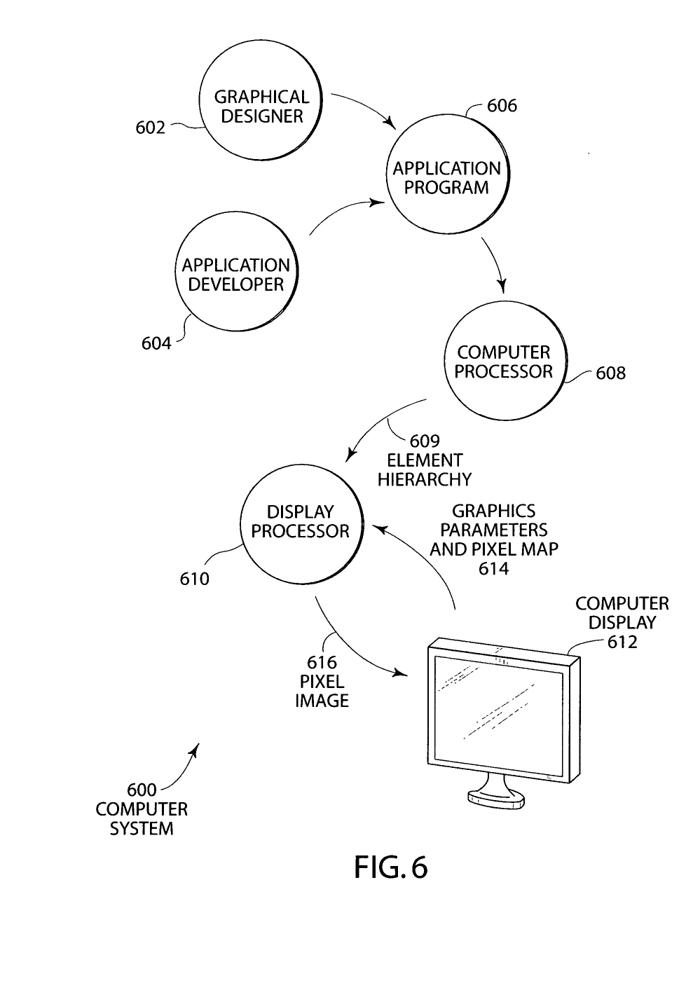

FIG. 6 is a diagrammatic illustration of an embodiment 600 showing a system for displaying an image. A graphical designer 602 and an application developer 604 may create an application program 606. Within the application program 606 is a hierarchical definition of graphical elements. The application program 606 may be executed on a computer processor 608 that sends an element hierarchy 609 to a display processor 610. The display processor 610 is connected to a computer display 612 and receives various graphics parameters and a pixel map 614. The display processor 610 applies pixel snapping to the element hierarchy 609 to generate a pixel image 616 that is displayed in the computer display 612.

The display processor 610 may be a separate software or hardware component that generates a displayable pixel image 616 from the output of the application program 606 running on the computer processor 608. In some embodiments, the display processor 610 may be a software component that is included in an operating system environment or another software component that is shared between several applications. The display processor 610 may also be a dedicated hardware device or combination of hardware and software device that performs the functions of pixel snapping.

The embodiment 600 illustrates a common application program 606 that may be used to generate images for many different displays 612 in many different configurations. For example, the application program 606 may be a generic program, but the display processor 610 may be able to adapt the pixel image 616 to apply to a large computer monitor with very dense pixel coverage but also generate an image that is visible on a small display on a handheld device such as a cellular phone. The display processor may use the graphics parameters and pixel map 614 to adapt the image for a very wide range of hardware configurations while maintaining a sharp image through pixel mapping.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a plurality of graphical elements using a device-independent coordinate system, said plurality of graphical elements being defined in a hierarchical tree structure, wherein a first graphical element is defined to be displayed using pixel snapping, said first graphical element having at least one graphical primitive being a child of said first graphical element; and
for each graphical primitive that is a child of said first graphical element, performing the following alignment method:
defining a first guideline defined by a first vertical boundary of said graphical primitive;
defining a second guideline defined by a first horizontal boundary of said graphical primitive;
calculating a first transformation such that said first guideline and said second guideline are aligned with a pixel map of a display device;
applying said first transformation to said graphical primitive; and
displaying said graphical primitive on said display device.

2. The method of claim 1 wherein said first graphical primitive being predominately rectangular in shape.

3. The method of claim 1 wherein said first vertical boundary is a rightvertical boundary of said first graphical primitive.

4. The method of claim 1 wherein said first vertical boundary is a left vertical boundary of said first graphical primitive.

5. The method of claim 1 wherein said first horizontal boundary is an upper horizontal boundary of said first graphical primitive.

6. The method of claim 1 wherein said first horizontal boundary is a lower horizontal boundary of said first graphical primitive.

7. The method of claim 1 wherein said alignment method further comprises:
defining a third guideline defined by a second vertical boundary of said graphical primitive;
defining a fourth guideline defined by a second horizontal boundary of said graphical primitive;
calculating a second transformation such that said third guideline and said fourth guideline are aligned with said pixel map of said display device; and
applying said second transformation to at least a portion of said graphical primitive that coincides with either of said third guideline or said fourth guideline.

8. The method of claim 7 wherein said second transformation is applied to said graphical primitive after said first transformation is applied.

9. The method of claim 7 wherein said second transformation is applied independently of said first transformation.

10. A computer readable medium comprising computer executable commands embodying the method of claim 1.

11. A system comprising:
a graphical display having a pixel map;
a processor adapted to:
receive a plurality of graphical elements using a device-independent coordinate system, said plurality of graphical elements being defined in a hierarchical tree structure, wherein a first graphical element is defined to be displayed using pixel snapping, said first graphical element having at least one graphical primitive being a child of said first graphical element; and
for each graphical primitive that is a child of said first graphical element, performing the following alignment method:
define a first guideline defined by a first vertical boundary of said graphical primitive;
define a second guideline defined by a first horizontal boundary of said graphical primitive;
calculate a first transformation such that said first guideline and said second guideline are aligned with a pixel map of a display device;
apply said first transformation to said graphical primitive; and
display said graphical primitive on said graphical display.

12. The system of claim 11 wherein said first graphical element being predominately rectangular in shape.

13. The system of claim 11 wherein said first vertical boundary is a left vertical boundary of said first graphical element.

14. The system of claim 11 wherein said first vertical boundary is a right vertical boundary of said first graphical element.

15. The system of claim 11 wherein said first horizontal boundary is an upper horizontal boundary of said first graphical element.

16. The system of claim 11 wherein said first horizontal boundary is a lower horizontal boundary of said first graphical element.

17. The system of claim 11 wherein said processor is further adapted to:
define a third guideline defined by a second vertical boundary of said graphical primitive;
define a fourth guideline defined by a second horizontal boundary of said graphical primitive;
calculate a second transformation such that said third guideline and said fourth guideline are aligned with said pixel map of said display device; and
apply said second transformation to at least a portion of said first graphical element that coincides with either of said third guideline or said fourth guideline.
